(19) United States
(12) Patent Application Publication
(10) Pub. No.: US 2008/0118650 A1
(43) Pub. Date: May 22, 2008

(54) PHOTOCHROMIC MATERIAL AND PROCESS FOR ITS PREPARATION

(75) Inventors: WERNER JENNINGER, Koln (DE); BURKHARD KOHLER, Zierenberg (DE); JOACHIM WAGNER, Koln (DE)

Correspondence Address: NORRIS, MCLAUGHLIN & MARCUS, PA, 875 THIRD AVENUE, 18TH FLOOR, NEW YORK, NY, 10022, US

(73) Assignee: BAYER MATERIAL SCIENCE AG, Leverkusen (DE)

(21) Appl. No.: 11/937,539

(22) Filed: Nov. 9, 2007

(30) Foreign Application Priority Data
Nov. 17, 2006 (DE) 10 2006 054 239.8

(51) Int. Cl. B05D 3/00; C08L 63/00

(52) U.S. Cl. 427/387; 524/494; 524/612

(57) ABSTRACT

A curable composition which has photochromic properties and is based on an amine-cured epoxy resin, a cured product which is obtained by thermal curing of this curable composition on a substrate, e.g. polycarbonate glass with triplex formation (three-layered structure), and a process for the preparation of an optical material are described.

The present invention relates to a curable composition having photochromic properties, a cured product which is obtained by thermal curing of this curable composition on a substrate, e.g. polycarbonate glass with triplex formation (three-layered structure), and a process for the preparation of an optical material. In particular, the invention relates to an amine-cured epoxy resin which can advantageously be used as an intermediate substance which is capable of imparting to an optical material, such as e.g. a polycarbonate triplex, readily photochemical properties by insertion of a composition between polycarbonate glasses, a cured product obtained therefrom, an optical material and a process for the preparation of optical material.

Photochromic triplexes, duplexes and films which are based on polymer compositions which comprise a certain amount of organic compounds which change color under incident light, which in general takes place on the basis of reversible chemical transfer reactions, e.g. ring opening and renewed cyclization reactions, are currently known. The photochromic organic compound can be used for coating a base material, e.g. a polymeric organic base material, or this can be added to it by various processes. Such processes include [see e.g. US 2006/0033088 A]:
a process for dissolving or dispersing a photochromic organic compound in the base material, for example a process with the addition of the photochromic organic compound to the monomeric base material before polymerization thereof;
a process with absorption of a photochromic organic compound into the base material by impregnation or convection of the base material in a high-temperature solution of the photochromic organic compound;
a process for providing a photochromic organic compound as its own layer between adjacent layers of base material, for example as part of the polymer film;
a process for using a photochromic organic compound as a coating material for the coating with which the surface of the base material is covered.

Compositions of a photochromic organic compound together with polymerizable oligomers and monomers are most widely used [US-A-6 926 510, US-A-5 910 516, US-A-5 621 017, US 2006/0023160 A, US 2006/0055070 A, US 2006/0033081 A, EP 1 433 814 A].

The common and essential disadvantage of all the products based on a photochromic organic compound is the limited life as a result of irreversible photochemical processes. In some cases, e.g. in the case of cheap sunglasses, the useable life (up to two years) is acceptable, the useable life in most other uses, e.g. in the case of lenses, protective screens, glass elements in buildings and vehicles and triplexes, ruling out the use of a photochromic organic compound.

At the same time, photochromic silicate glasses are currently generally known, and are distinguished by their ability to darken under the action of actinic radiation, substantially ultraviolet radiation, and to become colorless when this source of excitation disappears. The photochromism of such glasses in general develops as a result of the formation of a microcrystalline phase of silver halides in the glass (conventionally after thermal after-treatment of the glass). Since a use of such glasses was already generally known 30 years ago (US-A-3 208 860), such glasses have been employed with modifications in a number of various versions, depending on whether the one or the other photochromic feature has been optimized for the particular use (see e.g. US-B-6.177.371, US-B-6.165.922, US-B-6.162.749). It is significant that photochromic silicate glasses are distinguished by a unique photostability in sunlight. In general, the decisive properties of photochromic glasses for various uses are the following: their color and their degree of light transmission in the clear state (without actinic radiation), their color (conventionally grey or brown) and light transmission in the colored form under the action of actinic radiation, the low deviations in the degree of light transmission in the darkened state as a function of temperature, conventionally between 0 and 40° C., and their capacity for reversible decolorization after the exciting light source has disappeared.

The best photochromic properties are observed with photochromic glasses which contain light-sensitive AgCl microcrystals (for example commercial Corning glasses: Photobrown®/Photogray® Extra, Photobrown®/Photogray® Sunsitive, Photobrown® 16/45, Photogray® 16, Photogray® Thin & Dark, XDF Dark Gray).

Photochromic glasses PHG-5 based on light-sensitive CuHal microcrystals have moreover been developed (A. V. Dotsenko, L. B. Glebov, V. A. Tsekhomsky “Physics and Chemistry of Photochromic Glasses”, CRC Press, Boca Raton, N.Y., p. 190 (1998). In contrast to photochromic glasses containing AgHal, CuHal glasses darken not only under UV radiation, but also under visible light and infra-red light. They can consequently show the best light-induced changes.

However, the use of the abovementioned photochromic silicate glasses is complicated by their high weight, the risk of injury after breakages and the processing at very high temperatures (above 1,000° C.).

The abovementioned disadvantages can be eliminated by the development of hitherto unknown hydride-silicate/polymer glasses.

It is an aim of the present invention to provide a curable liquid composition of glycidyl ethers and amine curing agents which has a filler content of a powder of silicate glass impregnated with an inorganic photochromic compound, which can impart to a cured product excellent photochromic properties, in particular in respect of the long-term use of photochromic objects together with color development intensity and a high blowing speed, as well as excellent adhesion to a substrate.

A further aim of the present invention is the provision of a photochromic cured product having the above characteristic properties.

A further aim of the present invention is the provision of a photochromic optical material which comprises the photochromic cured product of the present invention on a substrate.

A further aim of the present invention is the provision of a photochromic polycarbonate triplex, which is formed by amine curing of the epoxy resin between polycarbonate glasses.

A further aim of the present invention is the provision of a process for the production of a photochromic cured product, which can provide a photochromic cured product having an excellent operating life.

Other aims and advantages of the present invention can be seen from the following description.

According to the present invention, the above aims and advantages of the present invention are achieved firstly by a curable composition which comprises at least the following:
A) 20 to 99 wt. % of at least one amine-cured epoxy resin and
B) 1 to 80 wt. % of a powder of silicate glass which contains an inorganic photochromic compound.

In the following, for short, component A) is also called binder and component B) is called filler.

The invention also provides a photochromic cured product which is obtained by curing of the curable composition of the invention.

The invention also provides a photochromic optical material which comprises at least one substrate which has a surface coated with a cured product from the curable composition according to the invention.

The invention furthermore provides a process for the preparation of a photochromic optical material which comprises at least one substrate which has a coated surface, characterized in that a film of the curable composition of the present invention is formed on at least one surface of a substrate and is subjected to thermal curing.

The invention moreover provides a process for the preparation of a photochromic optical material, in which a layer of an amine-cured epoxy resin is located between at least two polycarbonate glasses.

The present materials and processes for obtaining them have no equivalents.

In particular, the polycarbonate triplexes developed can be used for any desired uses of photochromic optical materials based on photochromic organic compounds, and moreover for the production of transparent objects intended for long-term use, such as e.g. as glass in building, vehicle and aircraft windows, protective screens, head coverings, motor-bike helmets, in particular windscreens etc.

What has been developed and has no equivalents is the set-up for the formation of photochromic materials using a curable composition based on amine-cured epoxy resins and silicate glass powder coated with an inorganic photochromic compound. The main advantage of this set-up is that a relatively simple epoxy matrix can be employed in order to obtain photochromic optical materials with a practically unlimited duration of use. The processability of the photochromic compound at least, in contrast to that of organic photochromic compounds, no longer represents a limiting factor.

One object is the formation of an epoxy resin which, after curing, results in a polymer having a refractive index which is as identical as possible to that of inorganic glass coated with an inorganic photochromic compound.

A further particular object relates to the establishing of the optimum size and form of photochromic glass particles of the filler, in order to achieve the required degree of filler content and the wettability by the constituents of the epoxy resin, as a result of which the transparency of the optical material is retained.

The use of adhesion promoters between the polymer and glass is furthermore advantageous.

Finally, the development of a process for obtaining optical materials represents a very important particular object, since distribution of super-fine filler in a viscous matrix where the materials have very different densities leads to the formation of air inclusions which are difficult to remove and to sinking of the filler during the process.

The preferred curable composition is first described, followed by other particular embodiments of the present invention.

To achieve an approximation between the refractive indices of binder A) and filler B), a mixture of polymerizable compounds is employed in the present invention. In particular, the amine-cured epoxy resin A) comprises:
60 to 100 wt. % of a mixture of amines A1) and epoxide compounds A2) in a manner such that 0.8-1.2 epoxide groups are present for each NH of the amine component A1) and
0 to 40 wt. % of accelerator and reactive or non-reactive diluent.

The diglycidyl ethers of bisphenols, such as bisphenol A or bisphenol F, or the polyglycidyl ethers of polyphenols, such as phenol/cresol novolaks, can preferably be employed as epoxide compound A2).

Polyether-amines of the formula (Ia) or (Ib)

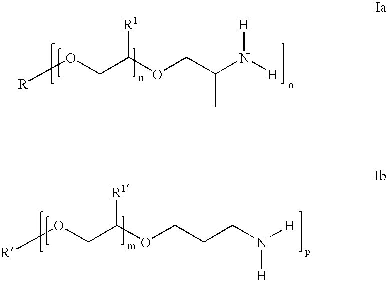

wherein R and R′ independently of one another represent a di- or trivalent radical obtained by removal of the OH groups from diols or triols, preferably from ethylene glycol, propylene glycol, glycerol or trimethylolpropane,

### R¹ and R^{1′} independently of one another represent hydrogen or methyl,

n and m independently of one another represent 0 to 23, preferably 3 to 23, and
and p independently of one another represent 2 or 3,
or ethylenediamine, oligoethyleneimines, such as diethylenetriamine or triethylenetetramine, piperazine, aminoethylpiperazine, IPDA or bisaminocyclohexylmethane
or mixtures of the amines mentioned can preferably be employed as amines A1).

The amine mixtures preferably contain at least 50 wt. % of the amines of the formulae (Ia) and (Ib).

Dicyandiamide, salicylic acid, salicylaldehyde, imidazoles, Mannich bases, such as 2,4,6-tri(dimethylaminomethyl)phenol or 2,2′,6,6′-tetra(dimethylaminomethyl)bisphenol A, ureas or thioureas can be employed as accelerators.

Non-reactive diluents are, for example, preferably monools, diols or triols, such as 1,4-butanediol, glycerol, benzyl alcohol, 2-ethylhexanol, cyclohexanol, adipol, esters of phthalic acid, isophthalic acid or terephthalic acid, triesters of phosphoric acid, sulfonic acid esters, diaryl ethers or haloaromatics.

Reactive diluents are, for example, preferably monoglycidyl ethers of phenol, cresol, or tert-butylphenol, or C₄-C₁₈ alcohols or diglycidyl ethers of diols, such as 1,4-butanediol, neopentylglycol or adipol or triglycidyl ethers of triols, such as trimethylolpropane or glycerol.

The epoxide compounds are commercially obtainable from many suppliers. The glycidyl ethers are an idealized structure. The commercially obtainable epoxide compounds are as a rule prelengthened by the structural element (II)

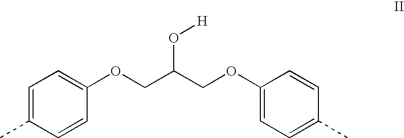

on average 0.3 to 3 structural elements of the formula II being present on a glycidyl ether.

The polyether-amines are commercially obtainable from Huntsman under the name “Jeffamine®” or from BASF under the name “Polyetheramin®”. The letters and numbers following the name explain the composition of the polyether-amines. There is no separate letter for polypropylene glycols, and “E” for polyethylene glycols. A following “D” stands for diamines, a following “T” for triamines. The number which follows represents the molecular weight (Mn).

A powder of any desired known inorganic glass can be used as filler B), as long as it contains an inorganic photochromic compound.

Examples by way of illustration of inorganic glasses include silicate glass containing AgHal, in particular AgCl, e.g. “Photogrey Extra™” (manufacturer Corning (USA)) or silicate glass containing CuHal, in particular CuCl₂, e.g. PHG-5 (manufacturer GOI, Russia).

In this context, the inorganic glass “Photogrey Extra™” from Corning (USA) is particularly preferred.

In the present invention, the powder of the photochromic inorganic glass is not subject to any particular limitations, and any desired known inorganic glass which is impregnated with any desired known inorganic photochromic compound can be used.

To improve the characteristic properties of the cured optical material with a filler content, e.g. the transparency and adhesion thereof, spherical photochromic filler particles are preferably used. The shape of these particles renders possible the production of high-quality triplexes, which are distinguished by good photochromic properties of the inner layer and adhesion as well as simplicity and a high level of filler content.

Nevertheless, anisodiametric powder particles (the length exceeds the width 2 to 5 times) with sharp facets of incorrect shape can be used. Examples by way of illustration include powders which are prepared by grinding photochromic AgCl-silicate glass “Photogrey Extra™” from Corning (USA). The first two particle fractions having the size of from 0.25 to 0.16 and 0.16 to 0.1 mm can be used for the filler content of curable compositions.

The size (diameter) of the filler particles can vary widely, the preferred size of filler particles being about 0.1 to 0.05 mm. In this case, triplexes of high quality and adequate transparency in a broad temperature range can be produced.

To improve the characteristic properties of the filler B), e.g. its adhesion to the cured polymer, the filler B) is preferably processed beforehand.

Any desired known adhesion promoters for silicate glasses e.g. can be used for this.

In the present invention, 3-(trimethoxysilyl)propyl methacrylate, tri(m)ethoxyvinylsilane, glycidyloxypropyltri(m)ethoxysilane, aminoethyl-aminopropyl-tri(m)ethoxyvinylsilane or aminopropyltri(m)ethoxysilane are preferably used. These compounds enter into sufficiently rigid chemical bonds with silicate glass specifically during hydrolysis. Due to the presence of the other functional groups, incorporation into the epoxy matrix can take place

A preferred process for treatment of the filler envisages filtering out of fractions in the low size range having an average particle size of less than 0.05 mm, decanting several times, initially in water, then in ethanol, and processing with an ethanol solution of an adhesion promoter, followed by drying at 60° C. until a constant weight is achieved.

In the present invention, a layer-for-layer process is preferably employed for coating the substrate surface with the liquid acrylate mixtures A) having a filler content. This process renders it possible to avoid intensive sorption of oxygen during mixing of the liquid oligomers and fillers as well as bubble formation.

For the preparation of high-quality photochromic optical materials, the filler B) is preferably introduced into the binder A), while at the same time the sample is heated to 40 to 50° C. Only in this case can evacuation of the liquid curable composition having a filler content be omitted.

In the present invention, the filler concentration is not subject to any particular limitations, but is preferably 1 to 75 wt. %, even more preferably 35 to 55 wt. %, based on the total amount of the compound, in order to improve the quality of the cured optical material. This value depends to a moderate extent on the binder composition.

### EXAMPLES

The following examples serve to illustrate the invention in more detail and are not to be understood as a limitation.

A powder of photochromic AgCl-silicate glass “Photogrey Extra™” from Corning (USA) having a particle size of from 0.25 to 0.16, which was pretreated by adding three times the amount of trimethoxyvinylsilane, heating at 80° C. for 2 h and then removing the excess silane in vacuo at 120° C., was employed as the filler B).

### Example 1

4 g B, 1 g 1,4-butanediol, 2.8 g technical grade bisphenol A diglycidyl ether (Sigma-Aldrich) and 2.2 g Jeffamine ED600 were mixed and the mixture was heated at 80° C. for 4 h. An almost transparent compound which darkened in color in sunlight was obtained.

### Example 2

5 g B, 1 g 1,4-butanediol, 2.2 g technical grade bisphenol A diglyidyl ether (Sigma-Aldrich) and 1.8 g Jeffamine ED600 were mixed and the mixture was heated at 80° C. for 4 h. An almost transparent compound which darkened in color in sunlight was obtained.

1. A curable composition comprising at least the following:
A) 20 to 99 wt. % of at least one amine-cured epoxy resin; and
B) 1 to 80 wt. % of a powder of silicate glass that contains an inorganic photochromic compound.

2. Composition according to claim 1, wherein the amine-cured epoxy resin A) comprises the following:
60 to 100 wt. % of a mixture of amines A1) and epoxide compounds A2) in a manner such that 0.8-1.2 epoxide groups are present for each NH of the amines A1); and
0 to 40 wt. % of accelerator and reactive or non-reactive diluent.

3. Composition according to claim 2, wherein the amine-cured epoxy resin A) comprises to the extent of at least 50 wt. % polyether-amines of the formulae (Ia) or (Ib): 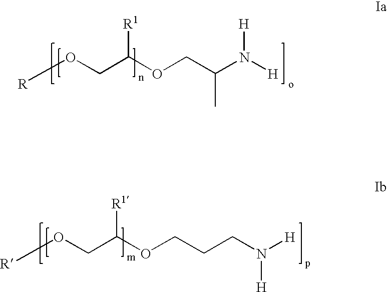
wherein R and R′ independently of one another represent a di- or trivalent radical obtained by removal of the OH groups from diols or triols;
R¹ and R^{1′} independently of one another represent hydrogen or methyl;
n and m independently of one another represent 0 to 23; and
o and p independently of one another represent 2 or 3.

4. Composition according to claim 2, which comprises a content of 1,4-butanediol as a non-reactive diluent.

5. Composition according to claim 1, wherein the filler B) is a photochromic compound chosen from halides of the elements of the first sub-groups of the periodic table of the elements.

6. Composition according to claim 1, wherein the filler B) is in spherical form.

7. Composition according to claim 1, wherein the filler B) comprises particles having a diameter of from 0.05 to 0.1 mm.

8. Photochromic cured product which is obtained by curing a curable composition according to claim 1.

9. Photochromic optical material which comprises a substrate which has at least one surface coated with a cured product of a curable composition according to claim 1.

10. Method of using the curable composition according to claim 1 for the production of photochromic polycarbonate multi-layered products.

11. Process for the preparation of a photochromic optical material which comprises at least one substrate having at least one coated surface, comprising forming a film of a curable composition according to claim 1 on at least one surface of the substrate and subjecting to thermal curing.

12. Process according to claim 11, which includes the step of layer-for-layer coating of at least one surface of a substrate with the curable composition.

13. Process for the production of a photochromic triplex by a process according to claim 11, which further comprises curing the curable composition between two substrates.
